(19) United States
(12) Patent Application Publication
(10) Pub. No.: US 2024/0018729 A1
(43) Pub. Date: Jan. 18, 2024

(54) BLOWER MEANS FOR A ROAD MAKING MACHINE

(71) Applicant: JOSEPH VOEGELE AG, Ludwigshafen/Rhein (DE)

(72) Inventors: Stefan WEBER, Roedersheim-Gronau (DE); Bernhard ERDTMANN, Edingen Neckarhausen (DE); Johannes PONTIUS, Schmelz (DE); Helmut KESSLER, Kaiserslautern (DE); Jan RIFFEL, Mannheim (DE)

(73) Assignee: JOSEPH VOEGELE AG, Ludwigshafen/Rhein (DE)

(21) Appl. No.: 18/221,236

(22) Filed: Jul. 12, 2023

(30) Foreign Application Priority Data
Jul. 14, 2022 (EP) 22184911.0

(51) Int. Cl. E01C 19/48; B08B 15/00

(52) U.S. Cl. CPC E01C 19/48; B08B 15/00; E01C 2301/00

(57) ABSTRACT

The disclosure relates to a blower means or apparatus for a road making machine which is present in the form of a road finishing machine or a charger vehicle for a road finishing machine. The blower means comprises a blower unit for creating an airflow, and an air discharge unit connected with the blower unit, which is designed to form an air barrier from the airflow created by means of the blower unit at a control station of the road making machine for an operator positioned therein. The blower means is designed as a modular attachment apparatus configured to be removably attached to the control station of the road making machine. The disclosure furthermore relates to the use of a blower means designed as a modular attachment apparatus at a road making machine.

### CROSS REFERENCE TO RELATED APPLICATIONS

This application claims foreign priority benefits under 35 U.S.C. § 119(a)-(d) to European patent application number EP 22184911.0, filed Jul. 14, 2022, which is incorporated by reference in its entirety.

### TECHNICAL FIELD

The present disclosure relates to a blower means or apparatus for a road making machine. The disclosure furthermore relates to the use of a blower means or apparatus that is employed as an attachment module for creating an air barrier at a road making machine.

### BACKGROUND

It is known that at road making machines, in particular at a road finishing machine for laying a new asphalt layer, suction systems are employed which in particular suck off fumes produced during the transverse distribution of the hot laying material from a spiral space positioned in front of the screed and eject them above the driver control platform of the road finishing machine. Such a suction system is disclosed in EP 0 843 044 A1.

Furthermore, at road finishing machines, fumes are also produced in the region of the material bunker in which the hot laying material is stocked, fumes to which in particular a driver of the road finishing machine is exposed. In order to suck off these fumes, EP 0 843 044 A1 proposes a further suction means. This suction means, too, ejects the fumes sucked off from the material bunker region above the roof.

In practice, fumes are also produced in the region of the material bunker in particular in a material transfer process in which the road finishing machine is supplied with fresh laying material, for example by a preceding charger vehicle or by means of a truck, the fumes flowing to the rear to the control platform of the driver.

DE 10 2020 123 723 A1 discloses a road finishing machine with a control platform having an air nozzle unit which is designed to create an air curtain around the control platform. The air nozzle unit may be integrated in a roof of the control platform. This is to prevent fumes produced during the installation from reaching the region of the driver.

The above-described suction/blower systems involve high construction efforts since they have different designs for each machine type. Across all series, various special manufactures are thereby developed, thus increasing manufacturing costs.

### SUMMARY

It is an object of the disclosure to provide a broadly applicable blower means or apparatus that can be inexpensively manufactured.

The disclosure relates to a blower means or apparatus for a road making machine which is present in the form of a road finishing machine or a charger vehicle for a road finishing machine. The blower means according to the disclosure comprises a blower unit for creating an air flow and an air discharge unit connected with the blower unit which is designed to form an air barrier from the air flow created by means of the blower unit at a control station of the road making machine for an operator positioned therein.

According to the disclosure, the blower means is at least partially designed as a modular attachment apparatus configured to be removably attached to the control station of the road making machine. Thus, the blower means according to the disclosure can be employed as a separate function unit, i.e., independent of the operation of a blower and/or suction component integrated in the road making machine, and in particular used for sucking off fumes from the spiral space, for forming the air barrier. Compared to such blower and/or suction components already integrated in the road making machine, the blower means according to the disclosure forms an off-grid attachment module which can be easily mounted by the operator on site, independent of the present machine types of the road making machine, that means across all series. This means that the blower means according to the disclosure can be employed as an off-grid attachment module as a standard at different road making machines, that means it is broadly applicable, and that consequently, manufacturing cost can also be reduced.

As a control station for removably attaching the blower means according to the disclosure, in particular a driver control platform of the road making machine is possible. However, it would be conceivable that the blower means according to the disclosure is removably fastened to the control station of the screed of a road finishing machine, that means at the external control station of the road finishing machine.

The blower means according to the disclosure forms a standard module attachable to various machine types which, despite its standardized modular construction, has a high potential for an individual employment at the road making machine. In particular, the blower means according to the disclosure can be easily adjusted by the operator thanks to its modular construction and its off-grid functioning in view of the weather situation on site without the operator having to adjust components integrated in the machine to this end. Basically, it is possible to set up an operation independent between the blower means according to the disclosure and other machine components, that means to have them running in an isolated manner.

Furthermore, the blower means according to the disclosure can be easily detached from the road making machine, in particular as a whole, due to its removable attachment. For example, the blower means can be deinstalled overnight, during transport drives, for service and/or cleaning purposes, with only a few movements of the hands.

The blower means according to the disclosure forms, in particular as a modular attachment apparatus, a compact module that can be altogether fastened to the road finishing machine in a compact design and easily visibly, whereby its operability can also be easily checked.

Preferably, the blower unit includes at least one centrifugal fan. The latter can suck in air axially along its motor axis and blows out the air offset about 90°. Such a centrifugal fan has a high efficiency and is above all suited for upstream and/or downstream units connected to it which operate with increased compressions and air pressures, respectively. Moreover, the centrifugal fan is suited for low-noise operation. It would be conceivable for the blower unit to include an axial-flow fan instead of a centrifugal fan. Due to its compact design, the weight of the blower means could be reduced thereby so that it is easier to handle as an attachment apparatus for an operator.

In one variant, the blower unit includes an electric motor, in particular a speed-controlled electric motor. To this end, the electric motor could be equipped with a separate speed control module, so that the blower means is even better suited for various machine types.

Preferably, the blower means can be controlled by means of an operator control panel of the road making machine, for example via an Ethernet, WLAN and/or Bluetooth connection to be established between the blower means and the operator control panel. In this context, it would be possible that a dynamic speed control of the electric motor of the blower means is accomplished depending on one or several measured process values during the operation of the road making machine. This function can be activated, for example, by means of the operator control panel of the road making machine. The dynamic speed control, however, could also be directly activated at the blower means.

It would be possible for the speed of the blower means to be set by means of an operating element provided thereat, for example by means of a rotary switch with a potentiometer. As an alternative or supplement, the speed of the blower means could be set by means of an operating element provided at the control station, for example by means of a rotary switch with a potentiometer.

In a simple variant, at least two power stages for the operation of the blower unit can be directly activated at the blower means. It would be conceivable to directly equip the blower means with a separate operating module. This operating module could include a display, in particular a touch display, for controlling and/or monitoring an operation of the blower means.

According to one embodiment, the operator could control the blower means by means of a mobile unit, for example by means of a smart device. The smart device can be designed in form of a smartphone, a tablet PC, wearables and/or data goggles.

According to one embodiment of the disclosure, the blower means is configured for a networked operation with at least one other attachment module attached to the road making machine, for example with a thermographic module and/or a weather module. It would in particular be possible for the speed control of the blower unit to be accomplished as a function of at least one process value measured at the other attachment module.

A suction effect could be improved by means of the blower means by the blower unit comprising an inflow nozzle with a cross-section diminishing in the direction of flow. This inflow nozzle causes a reduction of swirls on the suction side, so that the course of the flow can be optimized and noise emission reduced. The air sucked in through the inflow nozzle can be purposefully supplied to the centrifugal fan and be further accelerated by it towards the air discharge unit.

It would be helpful for the blower unit to include a filter at a blower inlet formed at the blower unit. The latter could be positioned, for example, in a nozzle opening of the inflow nozzle. It would be possible to arrange an access protection in front of the filter. It can also be present if no filter is installed at the blower means. The filter in particular prevents a soiling of the blower unit and furthermore takes care that the created air barrier has an improved air quality.

According to one embodiment of the disclosure, the blower unit can be connected with a power supply source of the road making machine. It would be conceivable that the blower means includes a power plug which can be connected with a socket mounted at the road making machine to supply the blower unit with power.

Preferably, the blower means includes at least one own accumulator (e.g., battery), for example, a lithium-ion accumulator, for an operation of the blower unit. Concerning power supply, the blower means is thus designed to be completely off-grid, i.e., operate completely in a self-sustaining manner. In one variant, the accumulator can be charged by means of the power supply source of the road making machine.

In one variant, the blower means comprises an air directing unit that, as a flow converter, axially directs the radial airflow formed by means of the blower unit into the air discharge unit. In particular, the air directing unit is designed to convert a radially distributed airflow axially sucked in by means of the blower unit into an axial airflow that is offset with respect to the axial inlet flow by 90°, and to direct it into the air discharge unit in this direction. Thereby, it is possible to achieve a high compression within the air discharge unit so that the air barrier created therewith forms a stable laminar flow that does not break away, i.e., that is comprehensively impermeable for fumes. Thus, a high shielding effect can be achieved.

Preferably, the air directing unit forms a housing for the blower unit. The air directing unit can thereby fulfill a double function, that means, besides the above-described flow converter function, also a protection function for the blower unit. The operating module of the blower means described above could be integrated in a surface formed by the air directing unit.

It is advantageous for the air directing unit, the air discharge unit, and/or the blower unit to be substantially made of plastic. This proves advantageous for a lightweight construction. In particular, the air directing unit and the air discharge unit can be completely made of plastic, for example each be composed of two injection molding shells. Except for the installed electronics, the blower unit can also be completely composed of plastic parts.

It would be conceivable that the air directing unit consists of several housing parts which form, in the assembled state, an accommodation for fixing the blower unit accommodated therein so that it assumes a predetermined orientation therein. According to one variant, the housing parts of the air directing unit can be assembled without tools, for example be mutually inserted by means of locking closures formed thereat, the locking having the effect that the blower unit accommodated therein is fixed free from backlash without any further fastening means being required for it.

In particular, it would be possible that an extension cord of the blower unit, at the end of which the power plug is fastened for connecting the blower means with the power supply source of the road making machine, can be wound on and off at the periphery of the air directing unit. In this variant, the air directing unit could also be employed as a cable drum.

In order not to obstruct the view of the operator of the road making machine, it would be advantageous for the air discharge unit and/or the air directing unit to be made of transparent plastic.

In one variant, the blower means includes at least one light source, for example at least one LED integrated therein. It would in particular be possible that, by means of the light source, the air discharge unit and/or the air directing unit can be illuminated at least partially. It would be conceivable that at least a portion of the components installed at the blower means can serve as a spotlight for night works.

According to a preferred embodiment, the air discharge unit and/or the air directing unit can be illuminated in different colors. For example, the air discharge unit and/or the air directing unit can be utilized as signal lights for a material transfer process. Green in particular indicates to a preceding material supply vehicle, for example a charger vehicle or a truck, that sufficient laying material is stocked in the material bunker. Red in particular signalizes that the laying material in the material bunker is nearly consumed, i.e., that feed is required. Thereby, the blower means forms a multifunctional attachment module which fulfills several purposes of application at a time. By the ability to emit color signals, it could also be signalized to a preceding material supply vehicle whether it is driving at a desired distance to the road making machine.

It would be possible for the blower means to include an optionally extendable mounting which is configured to position the blower means at a desired distance to the control station, in particular laterally spaced apart from a supporting beam of a driver roof. Such a mounting would in particular be useful if the blower means was employed at relatively small road making machines as a signal light or instruction light for a material transfer process. Thereby, the blower means designed as a signal light could be positioned at a sufficient distance laterally of the driver roof, so that it is easily visible by the driver of the material supply vehicle.

It would be conceivable for the air discharge unit to comprise at least one outlet nozzle designed in the form of an oblong fan nozzle or in the form of a flat nozzle to create a linear outlet flow as an air barrier. Thereby, a continuously quick, laminar outlet flow can be created, so that an effective air barrier for the operator is formed. The outlet nozzle can, as a flat nozzle or as a long nozzle, form a thin, flat laminar air jet, that means a thin air wall, which effectively shields, as an air barrier, a region that is exposed to fumes from a region in which the operator of the road making machine is positioned.

Preferably, the outlet nozzle formed as a flat nozzle includes an oblong, tubular body whose geometry, in particular whose length, diameter and/or periphery, is selected in view of the size of a structural part of the control station, which, for example, approximately corresponds to the size of a frame part employed for supporting the roof of the control platform. For example, the outlet nozzle constructed as a flat nozzle can have a length that substantially corresponds to the length of a front frame mounted at the control platform of the road making machine.

According to one embodiment, the air discharge unit, in particular its outlet nozzle, at least in sections includes a tubular-round, a tubular-square or a tubular-oval body, i.e., an oblong tube body whose tube cross-section can have different geometries.

The air discharge unit, in particular the outlet nozzle formed thereat as a flat nozzle, can be made of plastic, as already mentioned. This leads to a light construction. Preferably, the air discharge unit is composed of several (plastic) shell parts. They can thus be easily disassembled for service and/or cleaning processes.

In particular, the air discharge unit is articulated for adapting an orientation of the air barrier created by it, for example, it is mounted to be rotatable relative to the blower unit. For this, the air discharge unit can be fastened to an outlet of the air directing unit by means of a radial bearing. The radial bearing can be formed by a swivel joint which can be designed for continuous adjustment. As an alternative, it would be possible for the air discharge unit to be fastened at the outlet of the air directing unit at several predetermined angles. For example, the air discharge unit can be slipped on at the outlet of the air directing unit at various adjusting angles as a tubular attachment to fix a corresponding orientation of the outlet nozzle.

A variant that is particularly useful for practice is given by the air discharge unit being designed telescopically for varying an area of the air barrier created by it. Thereby, the blower means can be even better employed at control station constructions with different sizes. For example, this telescopic air discharge unit could include two tube sections shifting with respect to each other to vary the area of the air barrier.

In particular, the blower means could include at least one fastening means by which the blower means can be fastened to a supporting beam of the control platform, for example to a front frame or a rear frame. The fastening means can be designed such that it creates a closing effect whereby the air discharge unit can be automatically brought into a predetermined orientation, for example to extend along the supporting beam. As a fastening means, both frictional and interlocking joints are possible.

A compact design would in particular be given if at the road making machine, a supporting beam of the control platform itself, for example a front frame of the driver roof, a swiveling console of the driver seat, a seat console of the driver seat, or a frame part of the external control station, forms the air discharge unit. In this integral construction, the blower means utilizes a component already present at the control station of the road making machine as the air discharge unit. For this, at such a component, for example at the supporting beam of the driver roof, at the swiveling console of the driver seat, at the seat console of the driver seat, or at a frame part of the external control platform, at least one connection point can be formed at which the blower unit, in particular the air directing unit provided for it, can be removably fastened, the component itself being configured as a fan nozzle or flat nozzle, i.e., including an oblong outlet opening for forming the air barrier.

According to a variant, the blower means can be fastened to the driver control platform at a control panel guide fastened thereat which permits a repositioning of a driver control panel transverse to the direction of travel of the road making machine such that the air barrier flowing out of it forms a front pane of air at the driver control platform. This application is above all possible for driver control platforms without any physical front pane of glass or a similar pane material.

According to one embodiment of the disclosure, the air discharge unit comprises at least one outlet nozzle which is configured to create a radial outlet flow as an air barrier. In particular, the airflow created thereby can be created within a range of 360°, whereby at the control station, a particularly large air wall for the operator can be formed to protect him or her from fumes produced during the paving operation. To achieve this advantageous shielding effect, it is nevertheless possible for the air discharge unit itself to have a compact design.

According to a suitable construction, the air discharge unit is assembled from two (plate-like) shell parts which define a gap at their periphery as a circumferential outlet opening in the assembled state. Thereby, an air barrier, an air wall can be formed from a radial airflow. It would be conceivable for the outlet opening not to be designed completely circumferential, but to be only provided along a section of the periphery. The outlet opening could be designed, e.g., according to a segment of a circle, in particular according to a semicircle.

In an advantageous variant, the outlet opening formed between the plate-like shell parts can be at least partially closable continuously or by segments. It is thereby possible to vary the outlet direction and the area of the airflow created as the air barrier.

In particular, the blower unit is arranged as a centrifugal fan between the two plate-like shell parts. The plate-like shell parts can thus also be used as a housing of the blower unit. Here, the axial inlet flow formed by means of the centrifugal fan can be sucked in through an opening formed in one of the two shell parts, which in particular has a tapering cross-section in the direction of flow, and be conducted to the outlet opening in the radial direction.

The assembled plate-like shell parts in particular include an air space diminishing in the radial direction. Thereby, the assembled plate-like shell parts form a nozzle for forming the radial airflow. In this variant, an additional air directing unit can be omitted. The blower means is thus substantially present as a disk-like attachment apparatus which only requires little space for attachment in this form.

It would be conceivable that the plate-like shell parts form flow channels within the air space to purposefully conduct the radial airflow formed by means of the centrifugal fan to the outlet opening. This supports the forming of a radial air barrier. The plate-like shell parts can be manufactured from plastics for a light construction. In order to reduce the influence on visibility conditions of the operator, the plate-like shell parts are in particular made of transparent plastic.

According to a variant of the disclosure, the blower means is configured for an installation and deinstallation without tools. For example, the blower means can be easily fastened manually to a supporting beam or frame part of the road making machine by means of a quick lock mounting provided, for example, as a bent lever, bayonet or magnetic closure.

In particular, the blower means is designed for creating an air exit speed between 20 m/s and 30 m/s. Thereby, an air barrier with a sufficient shielding effect can be created. However, air exit speeds outside this range would also be conceivable.

The disclosure relates to a road making machine with at least one blower means mounted thereat as an attachment module. The blower means can in particular be fastened to a front frame of a roof construction of the driver control platform of the road making machine. It would be possible that at the front frame, a plurality of blower means according to the disclosure are fastened to form parallel air barriers.

In particular, the blower means can be fastened such that its air discharge unit extends along the front frame in the form of a tube at least in sections, in particular, however, completely. In this manner, the blower means could also be mounted to a rear frame of the control platform to create an air wall either to the front in the direction of travel, laterally of the control platform, or to create an air wall behind the control platform transverse to the direction of travel. By means of the latter air wall, fumes from the spiral space could be shielded.

As a further point of attachment of the blower means according to the disclosure, a swiveling console for a driver seat of the control platform of the road making machine would be possible. The direction of flow of the air barrier thus depends on the adjustment of the swiveling console. In a swiveled-in state, the laminar airflow is directed transverse to the direction of travel of the road making machine, whereby simultaneous fumes can be laterally blown away from the control platform. In a swiveled-out state, the laminar airflow is oriented more in the direction of the material bunker, so that fumes coming from this region can be better blocked.

A road making machine with at least one blower means mounted thereat would be conceivable, wherein the blower means is fastened to the control platform, to a front frame of a roof construction formed thereat, to a swiveling console for a driver seat, to a seat console of the driver seat, or to a frame part of an external control station of the road making machine, and wherein the front frame, the swiveling console, the seat console, or the frame part forms the air discharge unit of the blower means to which the blower unit is removably attached.

It would be conceivable for the blower means to be fastened at the road making machine at a fall-out protection of the driver seat of the control platform. For this point of attachment, in particular the air discharge unit is suited which is designed to create the radial airflow as an air barrier, that means which is present as a plate-like attachment module.

The blower means can in particular be mounted at the control platform of the road making machine such that air can be sucked off from an internal region of the control platform. It is in particular possible that the air discharge unit is oriented at the control platform such that a vacuum can be created in the internal region, i.e., within the control platform, by means of the air barrier created by it. Thereby, a suction effect within the control platform can be created for sucking off the atmosphere present therein, whereby an improvement of the air quality within the control platform can be achieved.

Above all, it would be conceivable in this context that the air discharge unit is employed at a blower means fixed to the swiveling console for sucking off air in the bottom region of the control platform. The air from the bottom region can here be pulled into the laminar airflow for forming the air barrier by means of the vacuum via the air discharge unit, that means along the surface thereof, and can be blown away from the control platform together with it.

The disclosure furthermore relates to the use of a blower means configured as a modular attachment apparatus to be removably attached to a road making machine for creating an air barrier by means of which fumes produced during the operation of the road making machine are kept away from an operator. The blower means according to the disclosure can be employed as an independent function unit, that means an off-grid attachment module at the road making machine which basically functions independent of other blower or suction components of the road making machine, if these are present, to effectively keep away fumes from the operator.

It would be conceivable that the modular blower means in its state attached to the road making machine is, besides its actual blower function, also employed as a lamp, in particular for a material transfer process.

### BRIEF DESCRIPTION OF THE DRAWINGS

Embodiments of the disclosure will be illustrated more in detail with reference to the following figures as examples. In the drawings:

FIG. 1 shows a road making machine configured as a road finishing machine without the blower means according to the disclosure;

FIG. 2 shows the road making machine configured as a road finishing machine of FIG. 1 with a blower means or apparatus according to the disclosure mounted thereat;

FIG. 3 shows the road making machine configured as a road finishing machine of FIG. 1 with a plurality of blower means according to the disclosure mounted thereat;

FIG. 4 shows a blower means according to the disclosure in an isolated representation;

FIG. 5 shows the blower means of FIG. 4 with an extended air discharge unit;

FIG. 6A shows a separately shown air discharge unit in the retracted position;

FIG. 6B shows the air discharge unit of FIG. 6A in an extended position;

FIG. 6C shows a cross-section through the air discharge unit of FIG. 6A;

FIG. 7 shows a blower unit of the blower means in an isolated representation;

FIG. 8 shows an air directing unit for the blower unit;

FIG. 9 shows an inflow nozzle of the blower means;

FIG. 10 shows a road making machine configured as a road finishing machine with a blower means for creating a radial airflow as an air barrier;

FIG. 11 shows the road making machine configured as a road finishing machine of FIG. 10 in a perspective representation without roof construction;

FIG. 12 shows the blower means employed at the road finishing machine of FIG. 10 in an isolated sectional representation; and

FIG. 13 shows a perspective representation of a road making machine configured as a charger vehicle.

Equal technical components are always provided with the same reference numerals in the figures.

### DETAILED DESCRIPTION

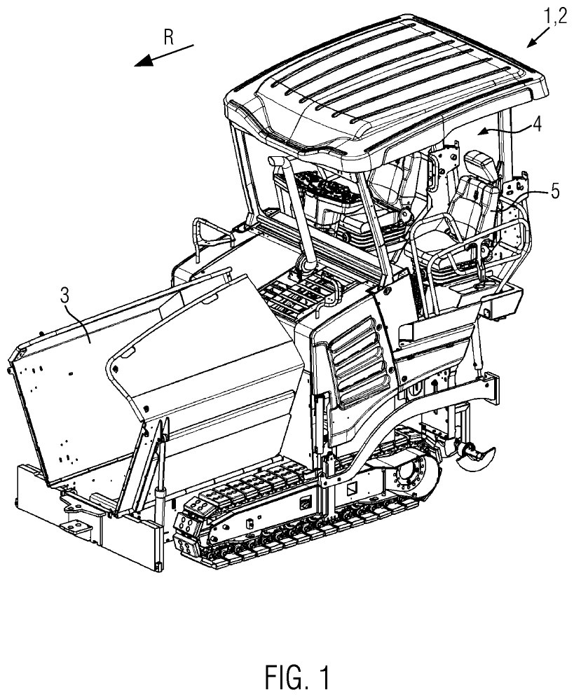

FIG. 1 shows a road making machine 1 which is present as a road finishing machine 2. The road finishing machine 2 has a material bunker 3 in which bituminous laying material can be stocked which is transported, by means of a longitudinal transport means not shown in FIG. 1, out of the material bunker 3, against the direction of travel R, to a neither shown screed towed by the road finishing machine 2 and is processed into a new road pavement by the same.

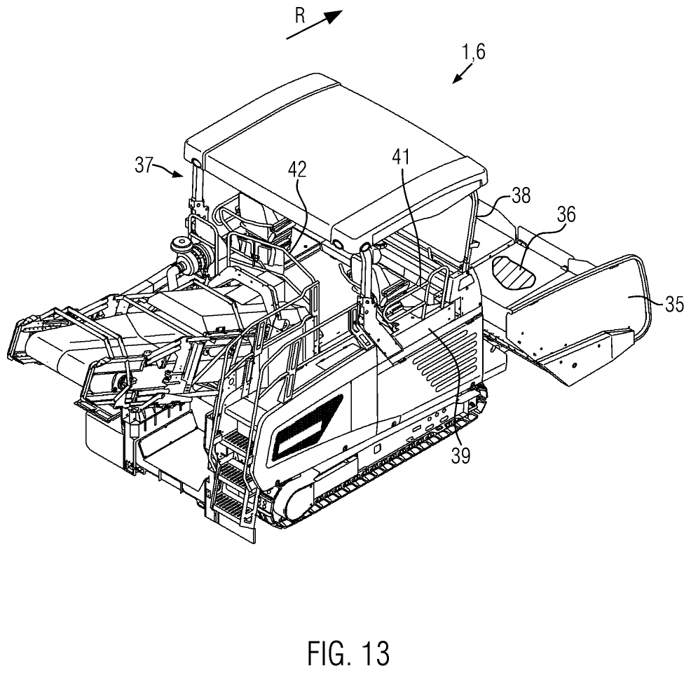

The road finishing machine 2 comprises a control platform 4 on which a driver seat 5 is positioned. In particular during a material transfer process in which laying material is transported into the material bunker 3, for example by means of a charger vehicle 6 (see FIG. 13) or by means of a truck, fumes rise from the material bunker 3 which can pass into the control platform 4. In an open state of the material bunker 3, fumes can reach the operator positioned on the driver seat 5 via the external sides of the control platform 4.

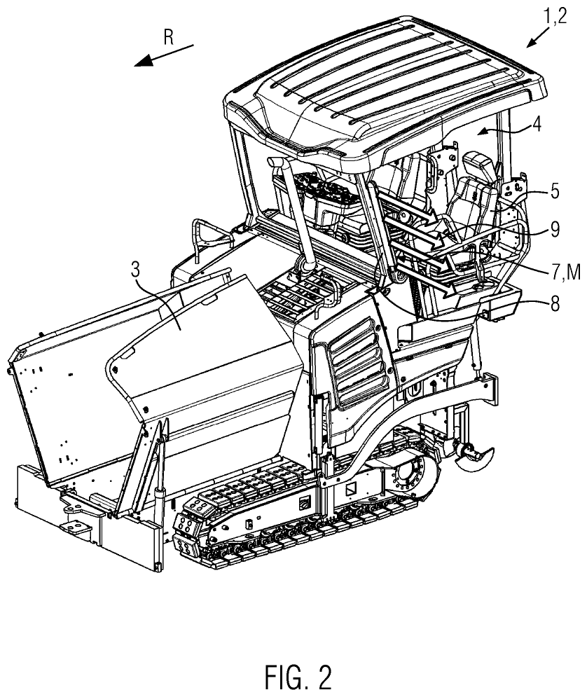

To keep these fumes away from the operator, according to FIG. 2, a blower means or apparatus 7 is arranged at the road finishing machine 2. The blower means 7 is configured as a separate attachment apparatus M and fastened to a front frame 8 of the control platform 4. According to FIG. 2, by means of the blower means 7, an air barrier 9 oriented transverse to the direction of travel R of the road finishing machine 2 is formed by means of an airflow exiting from the blower means 7 in a laminar manner. Thereby, the operator positioned on the driver seat 5 can be effectively shielded from fumes rising laterally of the road finishing machine 2, wherein the air barrier 9 created thereby simultaneously blows away the fumes reaching it transversely to the direction of travel R, i.e., away from the operator.

The blower means 7 shown in FIG. 2 is present as an autarkic modular attachment apparatus M for the road finishing machine 2. The blower means 7 can be easily fastened to the front frame 8 of the road finishing machine 2 and can, as is shown in FIG. 2, be oriented compactly along the front frame 8, so that the visibility conditions of the driver are not restricted.

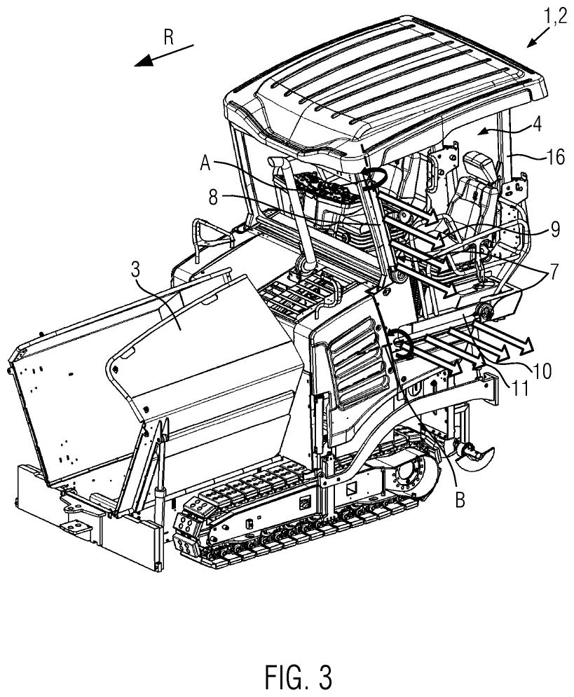

Furthermore, FIG. 3 indicates that the blower means 7 is rotatable with respect to an axis A that extends substantially in the direction longitudinal of the front frame 8 (e.g., upright direction). It is thereby possible to adapt a direction of propagation of the air barrier 9 relative to the control platform 4.

FIG. 3 shows the road finishing machine 2 of FIG. 1 with two blower means 7 attached thereat. One of them is fastened to the front frame 8 according to FIG. 2. The other blower means 7 is mounted to a swiveling console 10 on which the driver seat 5 is mounted. The swiveling console 10 may be pivotally mounted to a chassis or frame of the road finishing machine 2 so that the swiveling console 10 and the driver seat 5 may pivot with respect to the chassis or frame about an upright or vertical axis. By means of this blower means 7, a substantially horizontal air barrier 11 can be created next to the driver seat 5 which covers fumes rising laterally of the road finishing machine 2 like a carpet.

The blower means 7, fastened to the swiveling console 10 with respect to an axis B which substantially extends in the direction of travel R, is rotatable to be able to adapt the direction of propagation of the air barrier 11 relative to the control platform 4. For example, the blower means 7 could be adjusted such that the air barrier 11 is directed obliquely to the top so that no airflow is directed against construction site personnel working laterally next to the road finishing machine 2.

According to the air barriers 9, 11 adjusted in FIG. 3, an effective air shielding of the driver seat 5 can be set up. The two air barriers 9, 11 form air walls positioned laterally of the control platform 4. In particular, the respective air barriers 9, 11 can shield fumes reaching them from the operator and conduct them away from the operator.

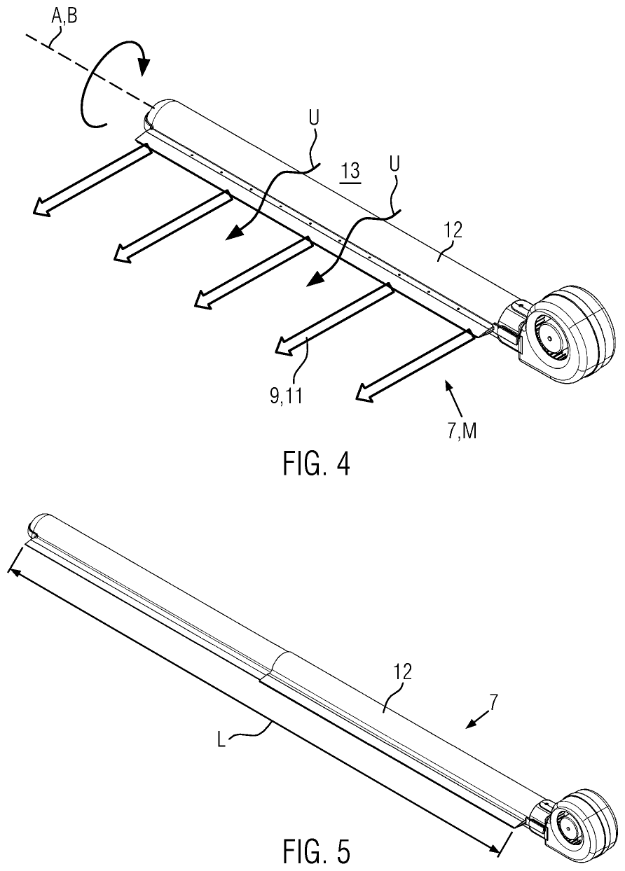

FIG. 4 shows the blower means 7 configured as attachment apparatus M in an isolated representation. As such a module, the blower means 7 can be employed at various construction machine types. The blower means 7 have an air discharge unit 12 of a tubular shape which is present as a flat nozzle corresponding to the length of which the air barriers 9, 11 can be created.

Furthermore, FIG. 4 schematically indicates that by means of a vacuum U resulting from the air barrier 9, 11 in a region 13 present on a side of the air discharge unit 12 facing away from the air barrier 9, 11, an atmosphere present in the region 13 can be sucked off. The air from the region 13, for example from the bottom region of the control platform 4, is included into the flow of the air barrier 9, 11 by the prevailing vacuum U. The linear airflow exiting from the air discharge unit 12 thus forms a suction effect in the region 13, so that atmosphere can be sucked off from it, i.e., also fumes optionally accumulated therein.

Furthermore, the air from the region 13 is also drawn into the airflow via the blower means 7 for creating the air barrier 9, 11 and can flow away from the control platform 4 together with it.

With respect to FIG. 3, it would thereby be possible to employ the blower means 7 which is fastened to the front frame 8 for sucking off an atmosphere from the region 13 lying behind it within the control platform 4. Equally, the blower means 7, which is fastened to the swiveling console 10 of the road finishing machine 2, could be employed to suck off atmosphere from the bottom region of the control platform 4. Thereby, the blower means 7 according to the disclosure can take care of an additional improvement of the air quality within the control platform 4 of the road finishing machine 2. The suction power by means of the blower means 7 can be adapted corresponding to a power of the blower means 7 for creating the air barriers 9, 11.

FIG. 5 shows the blower means 7 with the air discharge unit 12 mounted thereat in an extended position. According to FIG. 5, the air discharge unit 12 has a telescopic configuration. A length L of the air discharge unit 12 is thereby variable. It is thereby possible to adapt the length L of the air discharge unit 12 to a length of the front frame 8 or to a length of the swiveling console 10, respectively, to be employed at various road finishing machine and charger vehicle types, adapted to their constructive design.

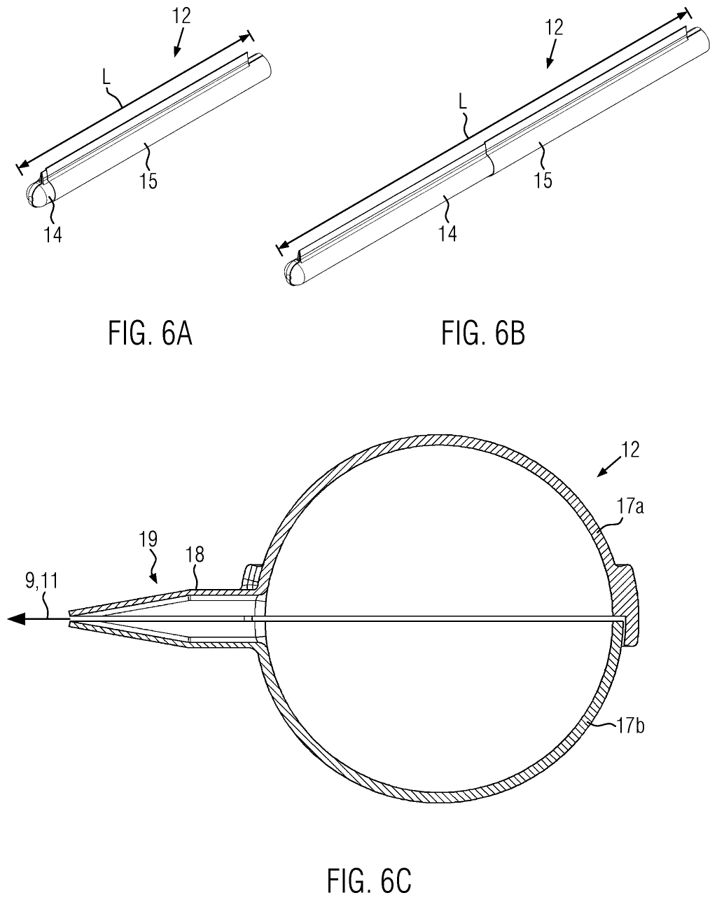

FIG. 6A shows the air discharge unit 12 in an isolated representation. The air discharge unit 12 is in a retracted position in FIG. 6A in which an internal tube section 14 is inserted into an external tube section 15. Thereby, the air discharge unit 12 is altogether short and can also be perfectly fastened to frame parts with short lengths, for example to the rear frame 16 of the control platform 4 (see FIG. 3).

FIG. 6B shows the air discharge unit 12 in an extended position. In the extended position, the air discharge unit 12 has a maximal length L. With this length L, a particularly large air barrier 9, 11 could be created by means of the blower means 7.

The telescopic air discharge unit 12 shown in FIGS. 6A and 6B can be employed at road making machines 1 of different sizes, in particular at a road finishing machine 2 of the compact class.

FIG. 6C shows the air discharge unit 12 in a cross-section. The air discharge unit 12 has, according to FIG. 6C, a substantially round cross-section. This cross-section could also have another geometry, for example square, oval, or the like. The air discharge unit 12 is composed of two shell parts 17a, 17b. The two shell parts 17a, 17b can be made of plastic. In an assembled state, the two shell parts 17a, 17b form an exit nozzle 19 in the form of a flat nozzle 18. From the exit nozzle 19, the air accelerated for forming the air barrier 9, 11 flows out in the linear direction.

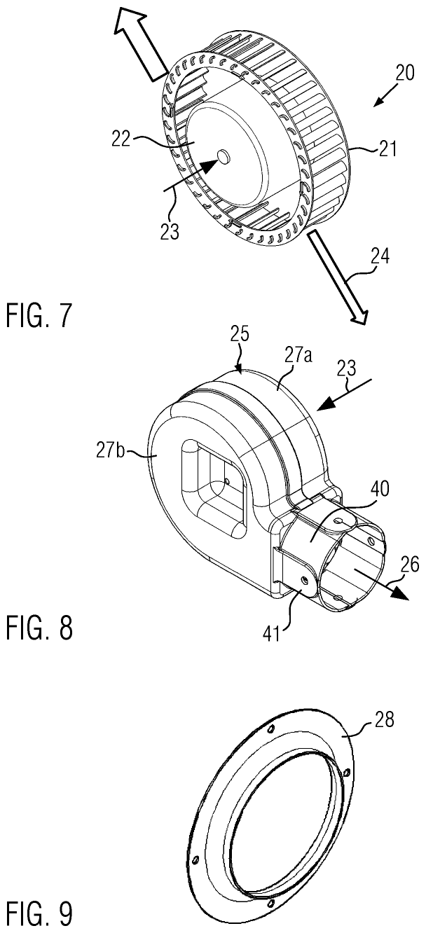

FIG. 7 shows a blower unit 20. The blower unit 20 is present as a centrifugal fan. The blower unit 20 has a fan wheel 21 and an electric motor 22 as a drive for the fan wheel 21. By the fan wheel 21 being rotated, an axial suction flow or inlet flow 23 forms in the direction of the fan wheel 21. The axial suction flow 23 is converted into a radial airflow 24 by means of the fan wheel 21. The fan wheel 21 can be made of plastic.

FIG. 8 shows an air directing unit 25 in an isolated representation. The air directing unit 25 is present as a housing for the blower unit 20 shown in FIG. 7. The blower unit 20 can be installed in the air directing unit 25 such that the radial airflow 24 created by the blower unit 20 and shown in FIG. 7 is converted into an airflow 26 which is again axially formed by means of the air directing unit 25. The air directing unit 25 thus forms, together with the blower unit 20 accommodated therein, a unit to axially suck in air from the surroundings of the air directing unit 25 and to discharge the same again substantially perpendicular to the intake.

Just as the air discharge unit 12, the air directing unit 25 can also be made of plastic, in particular be composed of two shell parts 27a, 27b. The air directing unit 25 can even be made of transparent plastic.

Furthermore, FIG. 8 shows that the air directing unit 25 includes a tube section 40. The latter serves to fasten the air discharge unit 12. FIG. 8 shows above all that the tube section 40 forms fastening elevations 41 by means of which the air discharge unit 12 can be fastened in various orientations rotated with respect to axes A, B.

FIG. 9 shows an inflow nozzle 28. The inflow nozzle 28 is positioned, in the assembled state of the blower means 7, at the entry of the air directing unit 25 to optimize the suction flow 23 and minimize noise emission.

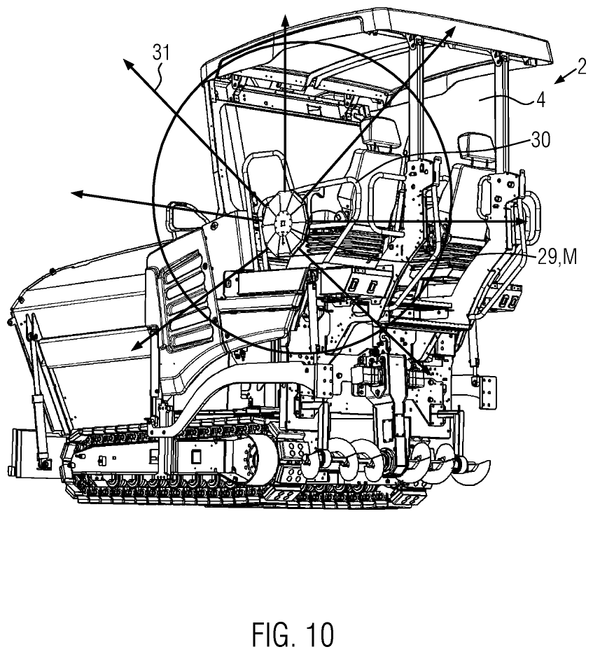

FIG. 10 shows the road finishing machine 2 with a further blower means or apparatus 29 configured as an attachment apparatus M which is attached to a fall-out protection of the control platform 4. The blower means 29 is designed to create a radial airflow as an air barrier 31 which propagates laterally of the control platform 4 in the radial direction. The blower means 29 can also be employed on both sides of the control platform 4.

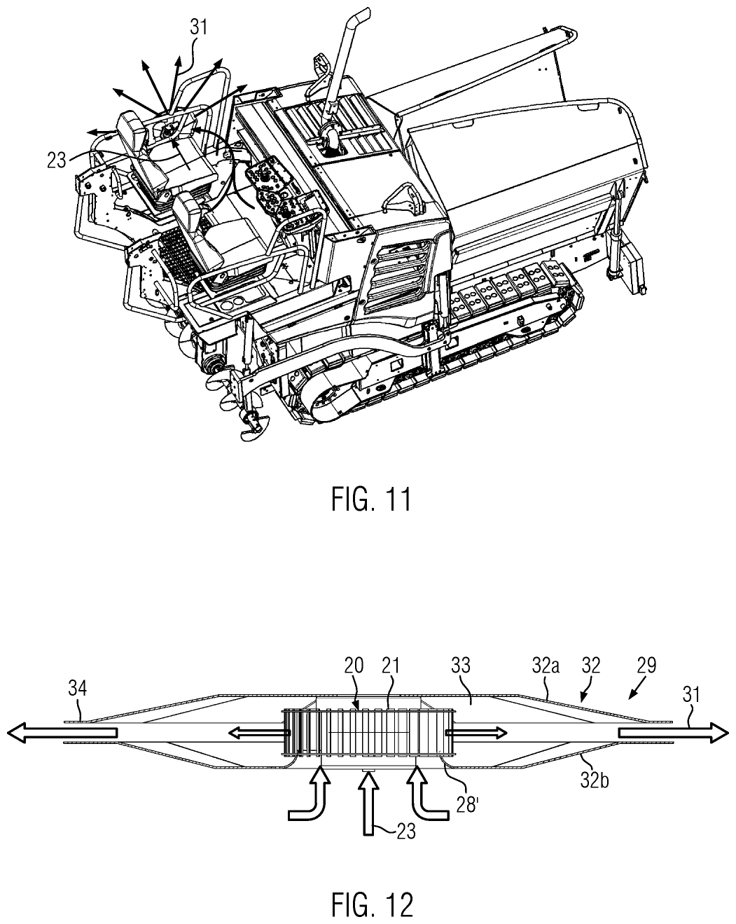

FIG. 11 shows the road finishing machine 2 of FIG. 10 without roof construction. FIG. 11 shows that the blower means 29 fastened to the fall-out protection 30 is configured to suck off air directly from the control platform 4 and to distribute it radially for forming the air barrier 31 along the open side of the control platform. The blower unit 20 inserted in the blower means 29 can here suck off atmosphere from the control platform 4 laterally of the driver seat 5 in a particularly effective manner.

FIG. 12 shows the blower means 29 in a cross-section in an isolated representation. The blower means 29 comprises two plate-like shell parts 32a, 32b which, when assembled, result in an air discharge unit 32 which is simultaneously present as a housing for the blower unit 20. In an assembled state, the two shell parts 32a, 32b include an air space 33 in which the blower unit 20 is received. The axial inlet flow 23 created by means of the blower unit is redirected in the radial direction by means of the fan wheel 21 and accelerated to the outside to form, by means of the linear airflow created thereby, the air barrier 31.

FIG. 12 shows that the two housing halves 32a, 32b form an outlet opening 34 at the periphery. FIG. 12 furthermore shows that the housing half 32b forms an inflow nozzle 28′ in the form of the inflow nozzle 28 of FIG. 9 at the entry of the blower unit 20. To create an effective air barrier 31, it is suited for the air space 33 formed between the shell parts 32a, 32b to become narrower from the blower unit 20 towards the outlet opening 34 whereby a sufficient nozzle effect results.

FIG. 13 shows a road making machine 1 configured as a charger vehicle 6. The charger vehicle 6 of FIG. 13 has a material bunker 35 which is configured to accommodate laying material 36. A control platform 37 of the charger vehicle 6 is substantially constructed as the control platform 4 of the road finishing machine 2. The blower means 7 can thereby be fastened, according to FIG. 3, at the front frame 38 and/or at the swiveling console 39 of the control platform 37. The swiveling console 39 may be pivotally mounted to a chassis or frame of the charger vehicle 6 so that the swiveling console 39 and associated driver seat may pivot with respect to the chassis or frame about an upright or vertical axis. The blower means 29 of FIG. 12 can be fastened at the fall-out protection 41 and/or at a rail 42 of the charger vehicle 6.

The described blower means 7, 29 each form autarkic attachment modules which can be fastened to the road finishing machine 2 and to the charger vehicle 6 to be operated thereat independent of other vehicle components. By them, air barriers 9, 11, 31 can be created on the control platform 4, 37 to shield the control platform 4, 37 from fumes produced by the hot laying material. Furthermore, the respective blower means 7, 29 can be employed for sucking off an atmosphere in the control platform 4, 37.

What is claimed is:

1. A blower apparatus for a road making machine which is configured as a road finishing machine or a charger vehicle for a road finishing machine, wherein the blower apparatus comprises a blower unit for creating an airflow, and an air discharge unit connected with the blower unit, which is designed to form an air barrier from the airflow created by the blower unit at a control station of the road making machine for an operator positioned thereat, wherein the blower apparatus is at least partially designed as a modular attachment apparatus configured to be removably attached to the control station of the road making machine.

2. The blower apparatus according to claim 1, wherein the blower unit includes at least one centrifugal fan, comprises an inflow nozzle with a cross-section diminishing in a direction of flow, and/or includes a filter at a blower inlet formed thereat.

3. The blower apparatus according to claim 1, wherein the blower unit is connectable with a power supply source of the road making machine, and/or the blower apparatus includes at least one accumulator for an operation of the blower unit.

4. The blower apparatus according to claim 1, wherein the blower apparatus comprises an air directing unit which forms a housing for the blower unit.

5. The blower apparatus according to claim 4, wherein the air discharge unit and/or the air directing unit are/is made of plastic.

6. The blower apparatus according to claim 1, wherein the air discharge unit forms a housing for the blower unit.

7. The blower apparatus according to claim 6, wherein the air discharge unit is made of plastic.

8. The blower apparatus according to claim 1, wherein the air discharge unit comprises at least one exit nozzle designed as a flat nozzle for creating a linear exit flow as the air barrier, or the air discharge unit comprises at least one exit nozzle for creating a radial exit flow as the air barrier.

9. The blower apparatus according to claim 1, wherein the air discharge unit is mounted, for adapting an orientation of the air barrier created by the air discharge unit, to be rotatable relative to the blower unit.

10. The blower apparatus according to claim 1, wherein the air discharge unit has a telescopic design for varying an area of the air barrier created by the air discharge unit.

11. Blower Apparatus according to claim 1, wherein the blower apparatus is configured for an installation and deinstallation without tools.

12. The blower apparatus according to claim 1, further comprising at least one light source.

13. The blower apparatus according to claim 1, wherein the blower apparatus is controllable by an operator control panel of the road making machine.

14. The blower apparatus according to claim 1, wherein at least two power stages are activatable for operation of the blower unit directly at the blower apparatus.

15. The blower apparatus according to claim 1, wherein the blower apparatus is attachable to the control station of the road making machine such that air can be sucked off from an internal region of the control station.

16. A road making machine comprising at least one blower apparatus according to claim 1, wherein a) a blower apparatus of the at least one blower apparatus is fastened to a front frame of a roof construction of a control station of the road making machine, and the air discharge unit extends longitudinally with respect to the front frame at least in sections, b) a blower apparatus of the at least one blower apparatus is fastened to a swiveling console for a driver seat of the control station of the road making machine, and the air discharge unit extends, in a direction of travel of the road making machine, along the swiveling console at least in sections, and/or c) a blower apparatus of the at least one blower apparatus is fastened to a fall-out protection laterally of the driver seat of the control station of the road making machine, and the air discharge unit is designed for creating a radial airflow as an air barrier laterally of the driver seat.

17. A road making machine comprising the blower apparatus according to claim 1, wherein the blower apparatus is fastened to a front frame of a roof construction of a control station of the road making machine, to a swiveling console for a driver seat, to a seat console of the driver seat, or to a frame part of an external control station of the road making machine, and wherein the front frame, the swiveling console, the seat console, or the frame part forms the air discharge unit to which the blower unit is removably attached.

18. A method of using a blower apparatus configured as a modular attachment apparatus for removable attachment to a road making machine, the method comprising creating an air barrier with the blower apparatus by which fumes produced during operation of the road making machine are kept away from an operator positioned on a control station of the road making machine.
